(19) United States
(12) Patent Application Publication
(10) Pub. No.: US 2002/0124866 A1
(43) Pub. Date: Sep. 12, 2002

(54) Plasma film-forming apparatus and cleaning method for the same

(75) Inventors: Shin Asari, Chiba-ken (JP); Naoto Tsuji, Chiba-ken (JP); Takaomi Kurata, Chiba-ken (JP); Kazuaki Yamauchi, Chiba-ken (JP); Masanori Hashimoto, Chiba-ken (JP); Michio Ishikawa, Chiba-ken (JP); Masayasu Hirata, Chigasaki-shi (JP); Katsuhiko Mori, Chigasaki-shi (JP)

Correspondence Address: Floyd B. Carothers, CAROTHERS AND CAROTHERS, Suite 500, 445 Fort Pitt Boulevard, Pittsburgh, PA, 15219, US

(73) Assignee: ULVAC, Inc.

(21) Appl. No.: 09/932,047

(22) Filed: Aug. 17, 2001

(30) Foreign Application Priority Data
Aug. 21, 2000 (JP) 250080/2000

(51) Int. Cl. C25F 3/30; B44C 1/22; C25F 1/00; C25F 5/00; C23F 1/00

(52) U.S. Cl. 134/1.1; 216/67; 118/726

(57) ABSTRACT

In a plasma film-forming apparatus which includes a film-forming chamber in which a substrate is arranged, a film-forming gas introducing pipe connected to a supply source of a film-forming gas at its first end, a shower plate through numerous holes of which a second end of said film-forming gas introducing pipe communicate with said film-forming chamber, film-gas exciting means for exciting film-forming gas introduced through said shower plate into said film-forming chamber, to form a film on the surface of said substrate with the chemical reaction, radicals-producing means which excites said cleaning gas and produces radicals, and cleaning-gas introducing means which introduces said cleaning gas containing said radicals into said film-forming chamber, the improvement in which said cleaning-gas introducing means communicate directly with said film-forming chamber.

### BACKGROUND OF THE INVENTION

1. Field of the Invention

This invention relates to a plasma film-forming apparatus and a cleaning method for cleaning the plasma film-forming apparatus.

2. Description of the Prior Art

FIG. 1 shows a plasma film-forming apparatus 1 of the prior art. It is an apparatus to form a film on a substrate 9 by a plasma CVD (Chemical Vapor Deposition) method. A cathode electrode 4 is arranged on the upper wall of a vacuum tank 2. An anode electrode 3 is arranged opposite to the cathode electrode 4, in a film-forming chamber 10 of the vacuum tank 2. The cathode electrode 4 is connected to a high frequency electric power source 8. The anode electrode 3 is connected to the earth. It functions also as a supporter for substrate. The substrate 9 is mounted on the anode electrode 3.

The cathode electrode 4 is dish-shaped. A gas-introducing pipe 13 is connected to a central hole of the upper wall of the cathode electrode 4. A shower plate 5 is fixed to a lower end of the cathode electrode 4. Numerous small holes are made in the shower plate 5 which is facing to the substrate 9.

One end of a film-forming gas introducing pipe 6 is connected to the gas-introducing pipe 13. Another end of the film-forming gas-introducing pipe 16 is connected to a not-shown film-forming gas supply source. A radicals producing source 11 is connected to one end of a gas-introducing pipe 12. Another end of the gas-introducing pipe 12 is connected to a not-shown cleaning gas sipply source. The radicals producing source 11 is further connected to the pipe 13.

Next, operations of the above described plasma film-forming apparatus 1 will be described.

For example, there will be described a case of forming a film of SiNx on the substrate 9. First, the film-forming chamber 10 is evacuated through an exhaust port 7 and so is put under the lower pressure. For example, SiH₄ gas and NH₃ gas are introduced onto the shower plate 5 through the film-forming gas introducing pipe 6 and the gas introducing pipe 13. They are ejected through the numerous holes of the shower plate 5 uniformly into the film-forming chamber 10 and toward the substrate 9.

Next, a high frequency electric power is supplied to the cathode electrode 4 form the high frequency power source 8, to decompose and make the introduced gases to react on each other gases in the film-forming chamber 10. Thus, a film of SiNx is formed on the substrate 9.

The above film-forming operations are repeated, and so SiNx films are adhered and piled onto the shower plate 5, anode electrode 3, cathode electrode 4 and inner walls of the vacuum tank 2 besides the substrate 9. The SiNx films on the above portions besides the substrate 9 should be removed (cleaned).

Next, there will be described cleaning operations of the interior of the film-forming chamber 10.

As on the film-forming operation, the film-forming chamber 10 is evacuated through the exhaust port 7 and so put under the lower pressure. For example, NF₃ gas is supplied into the radicals producing source 11. Microwave is applied to the NF₃ gas there, so that fluorine free radicals are produced there. NF₃ gas including fluorine free radicals are introduced into the film-forming chamber 10 through the gas-introducing pipe 13 and the shower plate 5.

Then, fluorine radicals react chemically on the materials (SiNx film) to be cleaned. The SiNx films piled on the inner wall of the vacuum tank 2 are removed. The removed SiNx materials are discharged through the exhaust port 7 together with the cleaning gas.

The method that the radicals for cleaning are thus previously produced and then introduced into the film-forming chamber 10, has the advantage that the plasma damage of the shower plate 5 is decreased, in comparison with the method that free radicals for cleaning are produced in the film-forming chamber 10 by the high frequency electric power applied to the cathode electrode 4 from the high frequency power source 8, as on the film-forming operation. introduced into the film-forming chamber 5, most of the radicals are dissipated, since the passing rate of the shower plate 5 having numerous small holes is low. Thus there is the problem that the cleaning rate is lowered.

Further, in consideration of the problem that most of the radicals are dissipated through in the shower plate 5, a very high frequency microwave such as 2.45 GHz is applied to the radicals-producing source 11 to produce more radicals, in some cases. However, such method requires high cost.

### SUMMARY OF THE INVENTION

Accordingly, it is an object of this invention to provide a plasma film-forming apparatus and the cleaning method that the dissipation of the radicals to be introduced into the film-forming chamber can be prevented.

Another object of this invention is to provide a plasma film-forming apparatus and the cleaning method that the radicals as the cleaning gas produced outside the film-forming chamber, can be effectively used for cleaning the film-forming chamber.

In accordance with one aspect of the invention, in a plasma film-forming apparatus which includes a film-forming chamber in which a substrate is arranged, a film-forming gas introducing pipe connected to a supply source of a film-forming gas at its first end, a shower plate through numerous holes of which a second end of said film-forming gas introducing pipe communicate with said film-forming chamber, film-gas exciting means for exciting film-forming gas introduced through said shower plate into said film-forming chamber, to form a film on the surface of said substrate with the chemical reaction, radicals-producing means which excites said cleaning gas and produces radicals, and cleaning-gas introducing means which introduces said cleaning gas containing said radicals into said film-forming chamber, the improvement in which said cleaning-gas introducing means communicate directly with said film-forming chamber. film-forming chamber.

In accordance with another aspect of the invention, in a cleaning method of a plasma film-forming apparatus which, in the film-forming operation, introduces a film-forming gas through a shower plate having numerous holes into a film-forming chamber, excites the introduced gas and forms a film, with the chemical reaction, on a surface of substrate arranged in said film-forming chamber, and in the cleaning operation, introduces a cleaning-gas containing radicals produced by exciting of said cleaning-gas, into said film-forming chamber and cleans said film-forming chamber by chemical reaction of said radicals and removes materials to be cleaned, the improvement in which said cleaning gas containing said radicals is introduced directly into said film-forming chamber.

### BRIFE DESCRIPTION OF THE DRAWINGS

FIG. 1 is a vertical cross-sectional view of a plasma film-forming apparatus of the prior art;

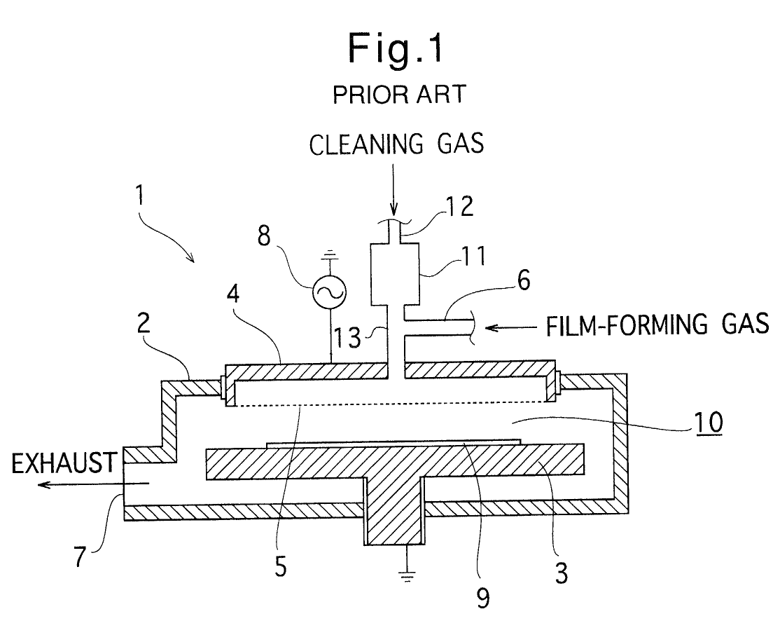

FIG. 2 is a vertical cross-sectional view of a plasma film-forming apparatus according to first and second embodiment of this invention;

FIG. 3 is vertical cross-sectional view of a plasma film-forming apparatus according to a third embodiment of this invention;

FIG. 4 is a cross-sectional view taken along the line iv-iv in FIG. 3;

FIG. 5 is a graph for showing the comparisons of the cleaning rates of SiNx films between the prior art and the first embodiment of this invention; and

FIG. 6 is a graph for showing the cleaning rates of SiOx film by the second embodiment of the invention.

### DESCRIPTION OF THE PREFERRED EMBODIMENTS

Next, embodiments of this invention will be described with reference to the drawings. The parts corresponding to the parts of the above prior art are denoted by the same reference numerals, the detailed description of which will be omitted.

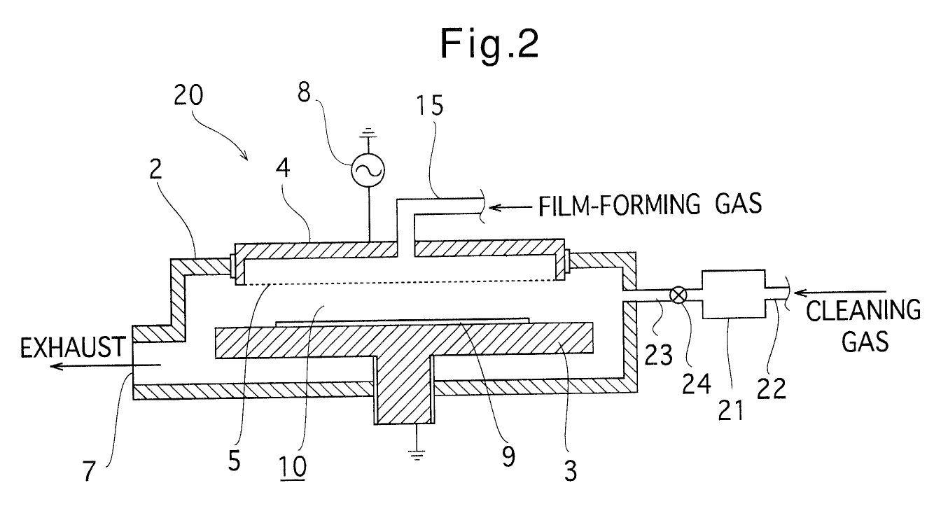

FIG. 2 shows a plasma (CVD) film-forming apparatus 20 according to a first embodiment of this invention. A cathode electrode 4 connected to a high frequency electric power source 8 is arranged in the upper wall of a vacuum tank 2. An anode electrode 3 supporting a substrate 9 and connected to the earth is arranged opposite to the cathode electrode 4 in the film-forming chamber 10.

A film-forming gas introducing pipe 15 is connected to a central hole of the upper wall of the cathode electrode 4. A shower plate 5 having numerous small holes is fixed to the lower end of the cathode electrode 4, opposite to the substrate 9.

A radicals-producing means 21 is arranged outside the vacuum tank 2. An input side of the radicals-producing means 21 is connected through a conduit 22 to a not-shown cleaning gas supply source. The radicals-producing means 21 consists of a chamber for a cleaning gas introduced from the conduit 22 and a high frequency electric power source applying a high frequency electric power to the contained cleaning gas in the chamber for producing radicals.

An output side of the radicals-producing means 21 is connected through a valve 24 to one end of a pipe 23 for introducing a cleaning gas. Another end of the pipe 23 is connected to a hole made in the side wall of the vacuum tank 2, positioning between the shower plate 5 and the anode electrode 3. Thus, the pipe 23 for introducing the cleaning gas directly communicates with the inside of the film-forming chamber 10.

In the film-forming operation, the film-forming chamber 10 is evacuated through the exhaust port 7 and is put under the lower pressure, as in that the prior art. A film-forming gas (SiH₄ gas, NH₃ gas) is supplied through the film-forming gas introducing pipe 15 onto the shower plate 5. It is ejected into the film-forming chamber 10 from the numerous small holes of the shower plate 5. A high frequency electric power is supplied to the cathode electrode 4 by the high frequency electric power source 8 to decompose and make the introduced film-forming gas reacting. Thus, a film of SiNx is formed on the substrate 9.

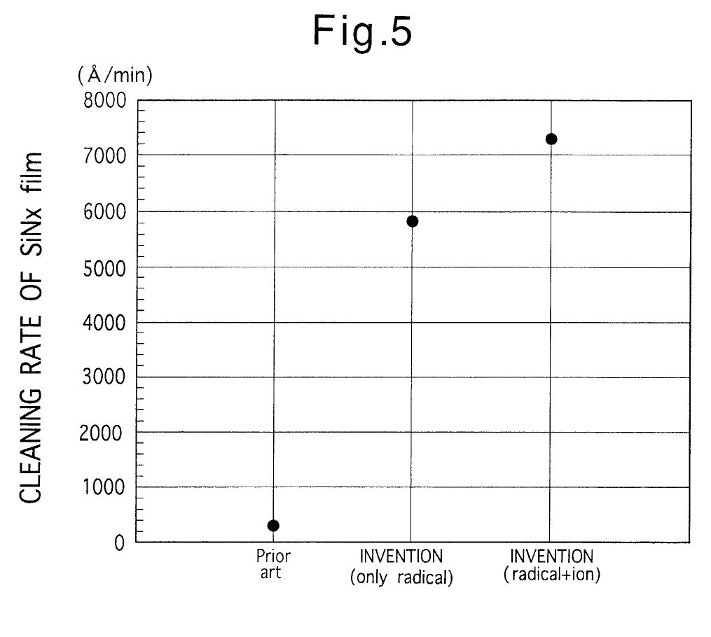

In the cleaning operation of the film-forming chamber 10, the film-forming chamber 10 is evacuated through the exhaust port 7 and put under the lower pressure. Then, the cleaning gas such as NF₃ gas is supplied to the radicals producing source 21 to which a high frequency electric power (400 kHz) is supplied. Fluorine radicals are produced in the radicals-producing source 21. The valve 24 is opened to introduce directly the NF₃ gas containing the fluorine radicals into the film-forming chamber 10 through the gas-introducing pipe 23 as the means for introducing the cleaning gas. The fluorine radicals react on the SiNx film to be cleaned. Thus, the interior of the film-forming chamber 10 is cleaned. Thus, in this embodiment, the radicals pass not through the shower plate 5, but directly introduced into the film-forming chamber 10 to be cleaned. Thus, most of the radicals can be prevented from dissipating before introduced into the film-forming chamber 10. The film-forming chamber 10 can be effectively cleaned. As shown in FIG. 5, the cleaning rate of the SiNx according to this embodiment is higher about twenty times than the prior art method in which the radicals pass through the shower plate 5.

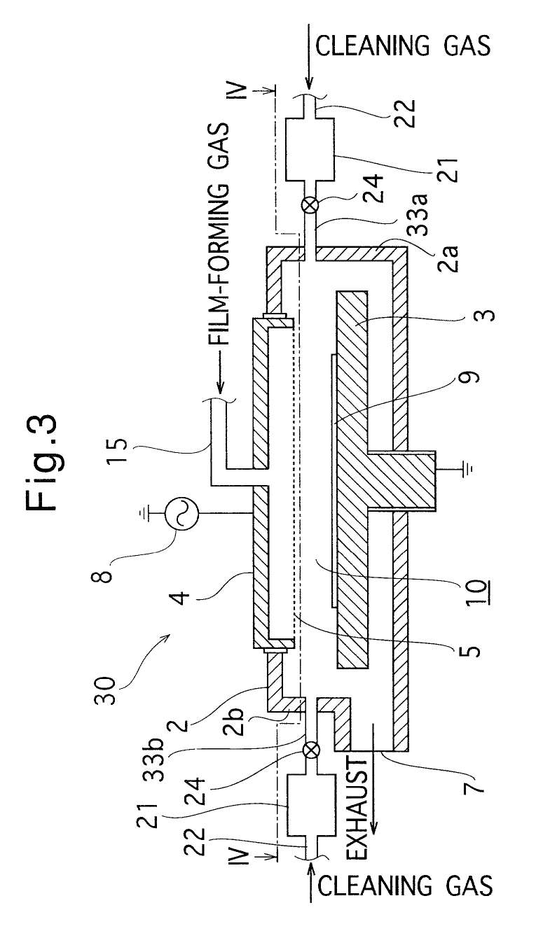

Further, the micro-wave generator of a high frequency such as 2.45 GHz was used for producing radicals in the radicals-producing means of the prior art. It is very expensive. In the embodiment of this invention, it is not necessary to use such as an expensive high-frequency electric power source. A high frequency electric power source of 400HKz, which takes lower cost, can be used to produce radicals. The experimental results as shown in FIG. 3 were obtained with the electric power source of 400 KHz. The frequency is not limited to 400 KHz. Similar effects can be obtained within the range of 100 to 1000 KHz. A high frequency electric power source of lower frequency than 1000KHz takes low cost. Accordingly, a plasma film-forming apparatus using such a high frequency electric power source takes lower cost, in comparison with the prior art plasma film-forming apparatus.

Further, in the embodiment of this invention, polyfluoro ethylene (trade name-Tefron) is coated on the inner surface of the cleaning gas introducing pipe 23. Accordingly, the radicals can be transported through the cleaning gas introducing pipe 23 without the dissipation. Thus, the life of the produced radicals can be longer.

Sufficient cleaning rate can be obtained for SiNx film, even only by radicals. However, radicals are very directional. Accordingly, there is the possibility that the films are not removed around the shower plate 5 and anode electrode 3, when only the radicals are used for cleaning. Accordingly, in the cleaning operation, Argon gas as inert gas for sputter cleaning is introduced into the film-forming chamber 10 besides NF₃ gas including fluorine radicals. A high frequency electric power of 27.12 MHz frequency and 0.15 W/cm² electric power density is applied to the introduced gases from the high frequency electric power source 8 which is used also for film-forming.

Thus, the argon gas is electrically devided into Ar ions (Ar⁺) and electrons. The film-forming chamber 10 is cleaned both with the chemical reaction by radicals and with Ar ions sputtering. It can be more uniformly cleaned, and the cleaning efficiency can be improved. The Ar gas is introduced into the film-forming chamber 10 through the cleaning gas introducing pipe 23 or through the film-forming gas introducing gas 15. Insteads, it may be introduced through a special pipe for spluttering gas.

Next, there will be described a second embodiment of this invention. SiO2 film is formed in the same plasma film-forming apparatus 20 as in the first embodiment. For example, SiH₄ gas and N₂O gas are used as a film-forming gas. The SiO₂ film is formed on the substrate 9 in the same manner as the first embodiment.

In the cleaning operation of the film-forming chamber 10, NF₃ gas containing fluorine radicals is directly introduced into the film-forming chamber 10 from the gas introducing pipe 23. The fluorine radicals reacts chemically with the SiO₂ film to be cleaned. Thus, the film-forming chamber 10 is cleaned.

Although the radicals are effectively introduced into the film-forming chamber 10, a sufficient cleaning rate cannot be obtained for SiO2 film. Accordingly, Ar gas is introduced into the film-forming chamber 10. The high frequency electric power is applied to the Ar gas from the cathode electrode 4 by the high frequency electric power source 8. Ar ions are produced. The film-forming chamber 10 is cleaned also by the Ar ion sputtering.

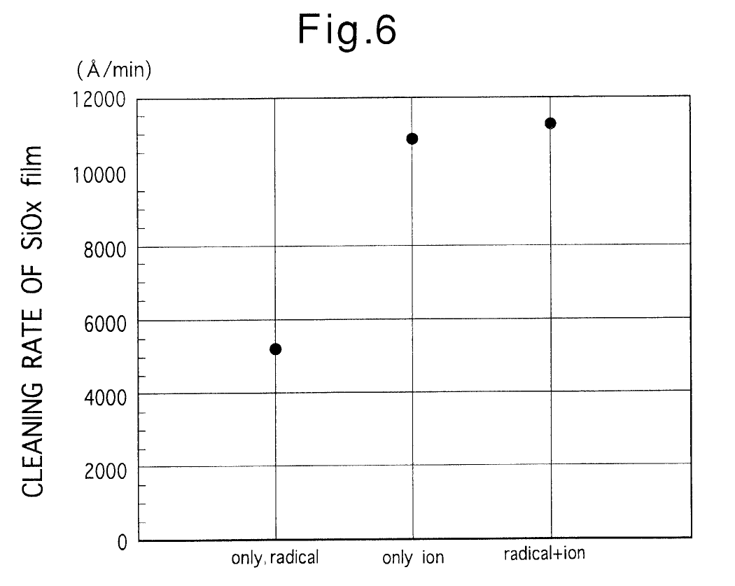

FIG. 6 shows the comparison results of the cleaning of the SiO2 films among the cleaning only by the radicals (fluorine radicals), the cleaning only by the ions (Ar⁺) and the cleaning by the ions (Ar⁺) and radicals. When the film-forming chamber 10 was cleaned only by the ions, the high frequency electric power was applied to the cathode electrode 4 at the frequency of 27.12 MHz and the power density of 0.67W/cm². When the film-forming chamber 10 was cleaned by the radicals and ions, the high frequency electric power was applied to the cathode electrode 4 at the same frequency as that of the cleaning only by the ions, and at the half power density of that of the cleaning only by the ions.

The cleaning rate of the cleaning operation only by the radicals are low. However, that of the cleaning operation by combination of the radicals and ions is substantially equal to that of the cleaning operation only by the ions. The required power of high frequency in the cleaning operation by combination of the radicals and ions is about half of that in the cleaning operation only by the ions. Accordingly, the plasma damage to the shower plate 5 can be reduced, and so the shower plate 5 can be prevented from being deteriorated.

Next, there will be described a third embodiment of this invention. Parts in this embodiment which correspond to those in the first and the second embodiments, are denoted by the same reference numerals, the detailed description of which will be omitted.

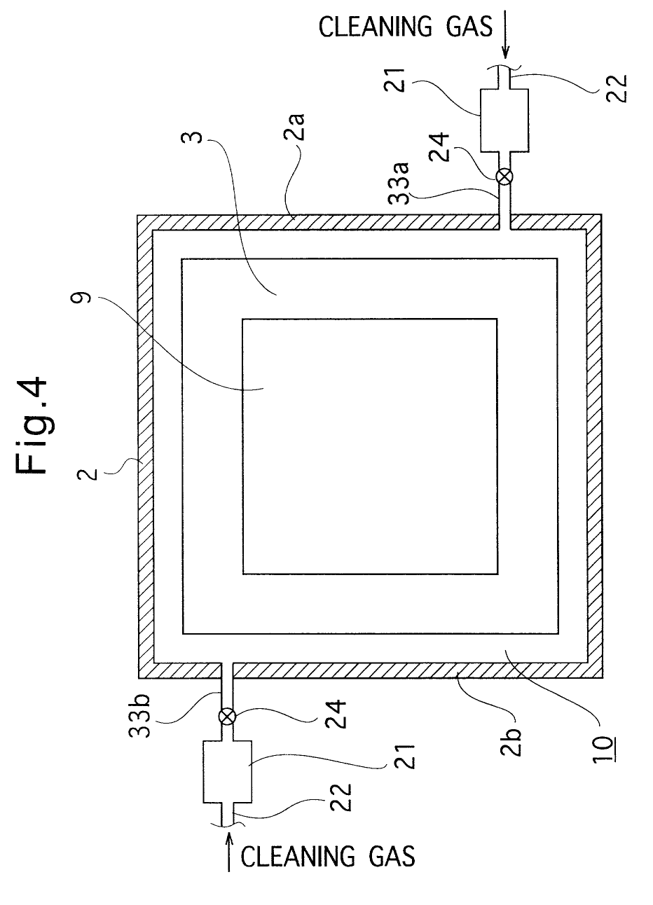

FIG. 3 shows a vertical cross-sectional view of a plasma film-forming apparatus 30 according to this embodiment. FIG. 4 shows a cross-sectional view taken along the lines IV-IV in FIG. 3. It is used for a large-sized substrate.

In the first and the second embodiments as shown in FIG. 2, the radicals are introduced laterally into the film-forming chamber 10. Accordingly, portions nearer to the outlet of the gas-introducing pipe 23 are sooner cleaned. When the size of the substrate 9 is about 400 mm×500 mm, there is no problem. However, when the size of the substrate is large as 730 mm×920 mm, the cleaning rate is generally lowered. The film-forming chamber 10 is large-sized for a large substrate. The cleaning rates are considerably different between portions near to the outlet of the gas-introducing pipe 23 and portions farther from that. Totally, the cleaning rate is lowered.

In this embodiment, a first cleaning-gas introducing pipe 33a is connected to one side wall 2a of the film-forming chamber 10, and another cleaning-gas introducing pipe 33b is connected to another side wall 33b of the film-forming chamber 10, which is facing to the one side wall 2b.

The cleaning-gas is introduced into the film-forming chamber 10 from the two outlets. As shown in FIG. 3, the first and second cleaning-gas introducing pipes 33a and 33b are shifted from the centers of the walls in opposite directions. The cleaning-gas is more uniformly introduced into the film-forming chamber 10 than in the case that the cleaning-gas introducing pipes 33a and 33b are connected to the walls, facing to each other. Of course, they may be connected to the walls, facing to each other.

The cleaning rate of the large film-forming chamber 10 with the arrangement of FIG. 4 is about three times as high as that in the case that only one cleaning-gas introducing pipe 22 is connected to the one side wall as in FIG. 2. The high frequency electric power source of about 100to 1000 KHz for producing radicals, is simple in constructions and small-sized in comparison with the micro-wave generator.

The price of the former is one third as low as that of the latter. Accordingly, plural radical-producing sources can be easily arranged, and the manufacturing cost is not so high.

While the preferred embodiments have been described, variations thereto will occur to those skilled in the art within the scope of the present inventive concepts which are delineated by the following claims.

For example, in the above embodiments, NF₃ is used as the cleaning-gas. However, it is not limited to NF₃, but CF₄, C₂F₆, C₃F₃, CHF₃, SF₆ etc. may be used as the cleaning-gas. Inert gas for sputtering cleaning is not limited to Ar. Further, the film to be formed in the substrate or to be cleaned, is not limited to SiNx and SiO₂. Further, the high frequency power to be applied to the cathode electrode 4, is not limited to the above frequency and to the above electric power density. Frequency between 10 to 100 MHZ may be adjusted.

Electric power density between 0.03 to 0.7 W/cm₂ may be adjusted.

In the third embodiment, two cleaning-gas introducing pipes are connected to the film-forming chamber 10. The number of the connected pipes is not limited to two, and more than two. The wall connecting the cleaning-gas introducing pipe, is not limited to the side wall, and may be upper wall or bottom wall, of the vacuum tank 2.

What is claimed is:

1. In a plasma film-forming apparatus which includes a film-forming chamber in which a substrate is arranged, a film-forming gas introducing pipe connected to a supply source of a film-forming gas at its first end, a shower plate through numerous holes of which a second end of said film-forming gas introducing pipe communicate with said film-forming chamber, film-gas exciting means for exciting film-forming gas introduced through said shower plate into said film-forming chamber, to form a film on the surface of said substrate with the chemical reaction, radicals-producing means which excites said cleaning gas and produces radicals, and cleaning-gas introducing means which introduces said cleaning gas containing said free radicals into said film-forming chamber, the improvement in which said cleaning-gas introducing means communicate directly with said film-forming chamber.

2. A plasma film-forming apparatus according to claim 1, in which said cleaning-gas introducing means comprises a first cleaning-gas introducing pipe communicating with said film-forming chamber from one of the opposite walls, and a second cleaning-gas introducing pipe communicating with said film-forming chamber from the other of the opposite walls and said first and second cleaning-gas introducing pipes are shifted from the centers of said walls in opposite directions.

3. A plasma film-forming apparatus according to claim 1 or 2 in which the inside surface of said cleaning-gas introducing means is coated with polytetra fluoro ethylene.

4. In a cleaning method of a plasma film-forming apparatus which, in the film-forming operation, introduces a film-forming gas through a shower plate having numerous holes into a film-forming chamber, excites the introduced gas and forms a film, with the chemical reaction, on a surface of substrate arranged in said film-forming chamber, and in the cleaning operation, introduces a cleaning-gas containing radicals produced by exciting of said cleaning-gas, into said film-forming chamber and cleans said film-forming chamber by chemical reaction of said radicals and removes materials to be cleaned, the improvement in which said cleaning gas containing said radicals is introduced directly into said film-forming chamber.

5. A cleaning method of a plasma film-forming chamber according to claim 4, in which, in said cleaning operation, inert gas is introduced into said film-forming chamber besides said cleaning gas containing radicals, said inert gas is excited to be inert ions, and said film-forming chamber is cleaned with the chemical reaction of said radicals and with the sputtering of said inert gas ions.
